(19) United States
(12) Patent Application Publication
(10) Pub. No.: US 2026/0147299 A1
(43) Pub. Date: May 28, 2026

(54) IMAGE FORMING APPARATUS

(71) Applicant: CANON KABUSHIKI KAISHA, Tokyo (JP)

(72) Inventors: SHIGEHARU KURITA, Chiba (JP); TOMOFUMI SAKUMA, Ibaraki (JP)

(21) Appl. No.: 19/389,516

(22) Filed: Nov. 14, 2025

(30) Foreign Application Priority Data
Nov. 28, 2024 (JP) 2024-207025

(51) Int. Cl. G03G 15/00; G03G 21/16

(52) U.S. Cl. CPC G03G 15/5016; G03G 15/80; G03G 21/1619; G03G 2221/1678

(57) ABSTRACT

Disclosed is an image forming apparatus including: an apparatus main body having outer casing surfaces; and an operation portion having an operation surface on which an input operation can be performed, the operation portion being configured to be rotatable around a rotation center axis such that the operation surface can take an inclined posture, wherein a user places a finger on the operation portion to perform a rotating operation of the operation portion around the rotation center axis, and wherein when viewing the operation surface of the operation portion from the above in the vertical directions, a gap is provided into which a user can insert a finger for performing the rotating operation between the operation portion and an outer casing surface adjacent to a circumference of the operation portion out of the outer casing surfaces.

### BACKGROUND

### Field of the Technology

This disclosure relates to an image forming apparatus with an operation portion.

### Description of the Related Art

In recent years, an apparatus with an operation portion of touch panel type as a user interface is proposed in image forming apparatuses such as multifunctional printer (MFP) (Japanese Patent Application Laid-open No. 2021-051130). The operation portion of touch panel type includes an operational surface on which an input portion such as a touch pad is disposed in a multilayered manner on a screen of the display portion such as a crystal display. By touching a display on the operational surface, an instruction for operating the image forming apparatus can be detected (input). Further, the above document discloses that the operation portion of touch panel type is rotated.

However, in the above related art, when an outer casing surface of the apparatus is adjacent to the circumference of the operation portion, it could be difficult to grip the operation portion due to the adjacent outer casing surface in operating the operation portion to rotate it.

### SUMMARY

One aspect of the present disclosure is an image forming apparatus comprising:
an apparatus main body having outer casing surfaces; and
an operation portion having an operation surface on which an input operation can be performed, the operation portion being configured to be rotatable around a rotation center axis such that the operation surface can take an inclined posture,
wherein a user places a finger on the operation portion to perform a rotating operation of the operation portion around the rotation center axis, and
wherein when viewing the operation surface of the operation portion from the above in the vertical directions, a gap is provided into which a user can insert a finger for performing the rotating operation between the operation portion and an outer casing surface adjacent to a circumference of the operation portion out of the outer casing surfaces.

Further features of the present disclosure will become apparent from the following description of exemplary embodiments with reference to the attached drawings. The following description of embodiments is described by way of example.

### BRIEF DESCRIPTION OF THE DRAWINGS

FIG. 1 is a schematic diagram showing a cross-sectional view of the image forming system including an image forming apparatus.

FIG. 2 is a diagram showing a perspective view of the image forming apparatus.

FIG. 3 is a diagram showing a perspective view of the circumference of an operation portion with a minimum inclined angle of the operation portion.

FIG. 4 is a diagram showing a perspective view of the bottom surface of the operation portion.

FIG. 5 is a diagram showing a detailed structure of a rotation center axis of the operation portion.

FIG. 6 is a diagram showing a perspective view of the circumference of the operation portion with a maximum inclined angle of the operation portion.

FIGS. 7A and 7B are explanatory diagrams showing a rotation operation of the operation portion viewed from right side surface of the right side surface.

FIG. 8 is a diagram showing a top view of the operation portion.

FIG. 9 is a diagram showing a front view of the operation portion.

FIG. 10 is a diagram showing a cross-sectional view of about the center portion of the operation portion.

FIG. 11 is a diagram showing a perspective view of the inner structures of an outer casings placed at a right side and a left side to the operation portion.

FIG. 12 is a diagram showing a perspective view of the inner structure of the outer casing placed at the left side to the operation portion.

FIG. 13 is a diagram showing a perspective view of the inner structure of the outer casing placed at he right side to the operation portion.

FIGS. 14A and 14B are explanatory diagrams showing a rotation operation of the operation portion viewed from the right side surface of the operation portion.

### DESCRIPTION OF THE EMBODIMENTS

Hereinafter, with reference to the drawings, embodiments of the present disclosure will be exemplarily described in detail. The sizes, materials, shapes and relative arrangement of the components described in the following are not intended to limit to only ones in the following embodiments as long as there is no specific descriptions.

### First Embodiment

In the following, an image forming system including an image forming apparatus according to the first embodiment will be described in detail referring to figures.

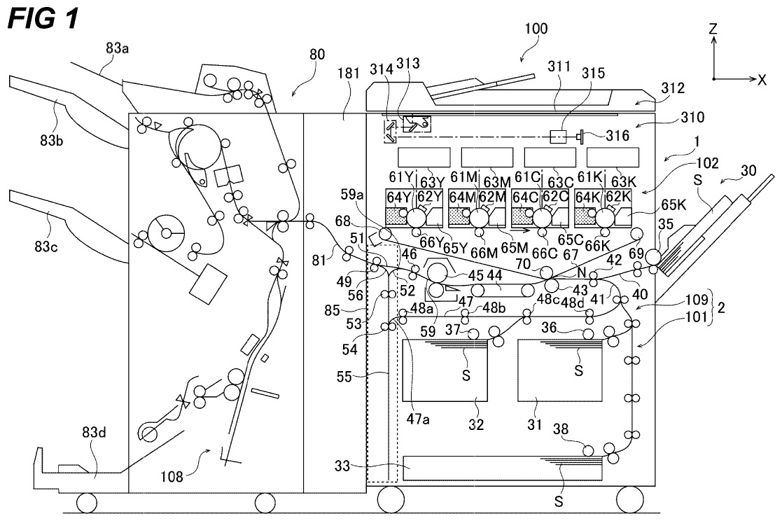

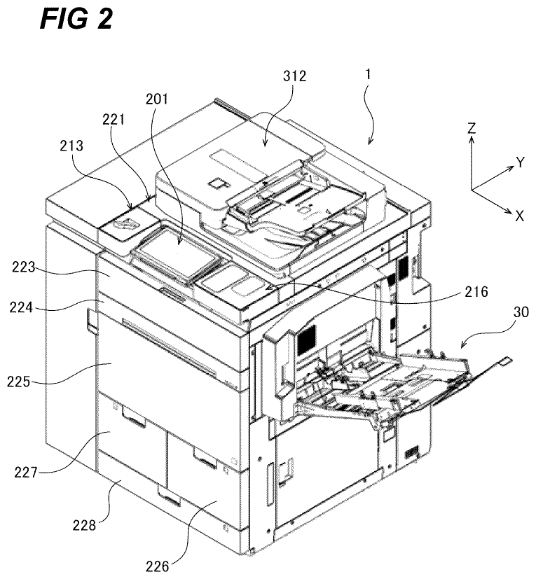

FIG. 1 is a schematic diagram showing a cross-sectional view of the image forming system 100 including the image forming apparatus 1 according to the first embodiment. FIG. 2 is a diagram showing a perspective view of the image forming apparatus 1.

The X-Y-Z coordinate system indicated in FIG. 1 or later figures is for describing the directions of the installed image forming apparatus. Specifically, X shows the width directions (leftward and rightward directions) of the image forming apparatus where the direction of the arrow shows the rightward direction and the direction opposite to the direction of the arrow shows the leftward direction. Next, Y shows the forward and backward directions of the image forming apparatus where the direction of the arrow shows the backward direction and the direction opposite to the direction of the arrow shows the forward direction. Finally, Z shows the height direction (upward and downward directions, vertical directions) of the image forming apparatus where the direction of the arrow shows the upward direction and the direction opposite to the direction of the arrow shows the downward direction. The dot at the intersection of the rear end points of arrows in any two axis right angle representation among X axis, Y axis, and Z axis indicates a front end point of the arrow on the axis other than the two axis right angle representation, and the dot superimposed by a cross indicates the rear end point of the arrow on the axis other than the two axis right angle representation.

The image forming system 100 has the image forming apparatus 1, the finisher 80 as an option unit connected to the image forming apparatus 1. In the present embodiment, the image forming apparatus 1 is a color image forming apparatus using electrophotographic system. In the present embodiment, the image forming apparatus 1 adopts intermedium transfer tandem system in which image forming units for four colors are disposed side by side above the intermediate transfer belt for the reason that excellence in adaptability to various sheets and printing productivity.

Further, in the present embodiment, the finisher 80 (sheet processing apparatus) has functions of performing processes of binding, folding, sorting, and so on to sheets.

Further, the document base 311 is provided on the upper surface of the image forming apparatus 1. The image reading portion 310 and the image forming portion 102 are provided inside the image forming apparatus 1. On the upper surface of the document base 311, the reversing automatic document feeder (RADF) 312 is mounted to have a predetermined positional relationship with the document base 311. The reversing automatic document feeder is supported to be openable with respect to the document base 311.

First, the reversing automatic document feeder 312 conveys a document such that one surface of the document faces the image reading portion 310 in a predetermined position. After the image reading for the one surface is finished, the reversing automatic document feeder 312 reverses and conveys the document toward the document base 311 such that the other surface faces the image reading portion 310 in the predetermined position. After the image reading of both surfaces of the document is finished, the reversing automatic document feeder 312 discharges this document and performs a conveying operation for both surfaces of the next document. The above conveyance of document and the reversing operation are controlled in relation to the overall operation of the image forming apparatus.

The image reading portion 310 is disposed under the document base 311 to read an image of a document conveyed to the document base 311 by the reversing automatic document feeder 312 The image reading portion 310 is provided with the first scanning unit 313 and the second scanning unit 314 as document scanning members that reciprocally move along and in parallel with the lower surface of the document base 311, the optical lens 315, and the CCD line sensor 316 as a a photoelectric conversion element.

The first scanning unit 313 is provided with an exposure lamp for exposing the surface of the document image, and the first mirror that deflects a reflected optical image from the document to a predetermined direction. The first scanning unit 313 reciprocally moves in parallel with the lower surface of the document base 311 at a predetermined speed while keeping a constant distance from the lower surface of the document base 311. The second scanning unit 314 is provided with the second and third mirrors that further deflect the reflected optical image that has been deflected by the first mirror of the first scanning unit 313 to a predetermined direction. The second scanning unit 314 reciprocally moves in parallel with the first scanning unit 313 while keeping a constant speed relationship with the first scanning unit 313.

The optical lens 315 reduces the reflected optical image from the document that has been deflected by the third mirror of the second scanning unit and focuses the reduced optical image in a predetermined position on the CCD line sensor 316.

The CCD line sensor 316 photoelectrically successively converts the focused optical image to output a corresponding electric signal. The CCD line sensor 316 is a three-line color CCD that can read a monochrome image or a color image and can outputs line data separated by respective colors of red (R), green (G) and blue (B). The document image information converted into the electric signal by the CCD line sensor 316 is transferred to an image processing portion (not shown) where a predetermined image data processing is performed for the information.

The image forming apparatus 1 is provided with the the sheet feeding portion 101 that feeds the sheet S (recording material, transfer material) such as a recording piece of paper, and the sheet conveying portion 109 that conveys the sheet S fed by the sheet feeding portion 101. In the present embodiment, the sheet conveying apparatus 2 is constituted by the sheet feeding portion 101 and the sheet conveying portion 109. Further, the image forming apparatus 1 is provided with the image forming portion 102 that forms an image on the sheet S conveyed by the sheet conveying portion 109.

The sheet feeding portion 101 is provided with the sheet accommodating portions 30 to 33 and the sheet feeding members 35 to 38.

The image forming portion 102 is provided with the photosensitive members 61 (61Y, 61M, 61C and 61K), the charging devices 62 (62Y, 62M, 62C and 62K), the exposure devices 63 (63Y, 63M, 63C and 63K), the developing devices 64 (64Y, 64M, 64C and 64K). Further, the image forming portion 102 is provided with the primary transfer devices 66 (66Y, 66M, 66C and 66K), the photosensitive member cleaners 65 (65Y, 65M, 65C and 65K), the intermediate transfer belt 67 on which tonner images formed on the photosensitive members 61Y, 61M, 61C and 61K are transferred, and the secondary transfer roller 43 as a secondary transfer device that transfers the tonner image transferred on the intermediate transfer belt 67 to the sheet S. The intermediate transfer belt 67 is stretched by rollers such as the driving roller 68 as a stretching roller, the tension roller 69 and the secondary transfer inner roller 70, and is rotationally driven (conveyed) in the direction indicated by the arrow R in the figure (clockwise direction). Further, the image forming portion 102 has the fixing device 45 that fixes a toner image transferred on the sheet S to the sheet S.

In the image forming apparatus 1, the secondary transfer roller 43 as a transfer portion that transfers an image to a sheet and the fixing device 45 as a fixing portion that fixes an image to the sheet are disposed on a sheet conveying path for conveying a sheet in the rightward and leftward directions. Namely, the image forming apparatus 1 has a lateral path for conveying a sheet in the leftward and rightward directions and does not have an inner discharge space into which a sheet is discharged between the image reading portion and the image forming portion in the vertical directions.

The sheet conveying portion 109 is provided with the conveying paths 40 and 41 as sheet conveying paths on which the sheet S travels that is fed by the sheet feeding members 35 to 38 of the sheet feeding portion 101, and the registration roller 42 that feeds the sheet S to the secondary transfer portion N (secondary transfer nip) that is an abutting portion of the intermediate transfer belt 67 and the secondary transfer roller 43. Further, the sheet conveying portion 109 is provided with the pre-fixation conveying belt 44 that sends the sheet S on which a toner image has been transferred to the fixing device 45. The post-fixation conveying path 59 having the discharge inner roller 46 is disposed downstream of the fixing device 45. Further, the sheet conveying portion 109 is provided with the reversing portion 85 that performs switchback conveyance for the sheet S downstream of the post-fixation conveying path 59 in the conveying direction of the sheet S. The post-fixation conveying path 59 and the reversing portion 85 are connected to each other via the outlet port 59a of the post-fixation conveying path 59 that is a first horizontal path that is effectively horizontal.

The reversing portion 85 is provided with the discharge conveying path 51, the reverse induction path 52, the switchback path 55, and the reverse discharge path 56. The discharge conveying path 51 whose upstream side in the conveying direction is connected to the post-fixation conveying path 59 is a conveying path for guiding the sheet S for the sheet S on which an image has been formed to be discharged. The reverse induction path 52 whose upstream side in the conveying direction is connected to the post-fixation conveying path 59 is a sheet conveying path branched from the discharge conveying path 51. The switchback path 55 is a conveying path into which a sheet having passed through the reverse induction path 52 is drawn for reversing the front and back sides and the leading and trailing ends in the conveying direction of the sheet S on which an image has been formed. The reverse discharge path 56 is a sheet conveying path merged into the discharge conveying path 51 for guiding the sheet S that has been drawn into the switchback path 55 to discharge it from the image forming apparatus 1. The reversing portion 85 is provided with the reversing upper roller pair 53 and the reverse lower roller pair 54 as conveying members provided in the switchback path 55. Further, the reversing portion 85 is provided with the discharge outer roller 49 as a conveying member that conveys the sheet S having been discharged from the fixing device 45.

Further, the sheet conveying portion 109 is provided with the duplex conveying path 47 that is a sheet conveying path for conveying the sheet S whose conveying direction has been reversed in the switchback path of the reversing portion 85. The switchback path 55 and the duplex conveying path 47 are connected to each other via the inlet port 47a of the duplex conveying path 47 that is a second horizontal path that is effectively horizontal. The duplex conveying path 47 is connected to the conveying path 41. Further, the sheet conveying portion 109 is provided with the duplex rollers 48a to 48d that are conveying members that convey the sheet S having passed through the duplex conveying path 47.

Further, as shown in FIG. 2, the image forming apparatus 1 is provided with the operation portion 201. The operation portion 201 functions as a display portion that displays the information in relation to the image forming apparatus 1 as well as an input portion that inputs various settings and so on to the image forming apparatus 1.

The finisher 80 is provided with the buffer path unit 181 that conveys the sheet S discharged from the image forming apparatus 1 and the post-processing unit 108 (finisher main body) that processes the sheet S conveyed by the buffer path unit 181. The buffer path unit 181 is provided with the buffer path 81 that is a sheet conveying path for guiding the conveyance of sheet S to the post-processing unit 108. The buffer path 81 connected to the downstream side of the discharge conveying path 51 of the image forming apparatus 1 in the conveying direction of the sheet S. The finisher 80 is provided with the discharge stacking portions 83a to 83d to which the sheet S processed by the post-processing unit 108 is discharged. The buffer path unit 181 and the post-processing unit 108 may be separated and the image forming apparatus 1 may be connected to the post-processing unit 108 via the buffer path unit 181.

The sheets S are stacked and accommodated in the sheet accommodating portions 30 to 33 and fed by the sheet feeding members 35 to 38 in synchronism with the timing of image forming in the image forming portion 102. The sheets S fed by the sheet feeding members 35 to 38 are conveyed to the registration roller 42 via the conveying paths 40 and 41.

The conveyed sheet S abuts against the registration roller 42 so that a loop shape is formed on the sheet S. As a result, the leading edge of the sheet S follows the registration roller 42 so that the skew feeding is corrected. After the skew feeding is corrected, the registration roller 42 feeds the sheet S to the secondary transfer portion N at a predetermined timing in synchronism with the timing of the image forming to the sheet S. Namely, the registration roller 42 conveys the sheet S to the secondary transfer portion N in synchronism with the timing where the toner image borne on the intermediate transfer belt 67 as an image bearing member arrives at the secondary transfer portion N.

The secondary transfer portion N is a nip portion formed by the secondary transfer inner roller 70 and the secondary transfer roller 43, which are disposed to be opposed to each other via the intermediate transfer belt 67. The secondary transfer portion N transfers the toner image to the sheet S. The toner image is (secondarily) transferred to the sheet S in the secondary transfer portion N by applying a predetermined pressurizing force and the electrostatic load bias.

The image forming process performed in the same time period of the sheet conveying process to the secondary transfer portion N will be described. The surface of the rotating photosensitive member 61 is uniformly charged by the charging device 62. The surface of the charged photosensitive member 61 is scanned and exposed by the exposure device 63. The exposure device 63 is driven based on the sent signal indicative of the image information. As a result, an electrostatic latent image (electrostatic image) is formed on the photosensitive member 61. The electrostatic latent image formed on the photosensitive member 61 is developed (visualized) by the developing device 64 using toner as developer. As a result, a toner image is formed on the photosensitive member 61. The toner image on the photosensitive member 61 is (primarily) transferred to the intermediate transfer belt 67 by applying a predetermined pressurizing force and electrostatic load bias by the primary transfer device 66. Slightly remaining toner on the photosensitive member 61 after the primary transfer process (remaining toner after transfer process) is removed from the photosensitive member 61 and collected by the photosensitive member cleaner 65.

In forming a full-color image, the above described image forming process is performed for the colors of yellow (Y), magenta (M), cyan (C) and black (K). The toner images of respective colors of Y, M, C and K formed on the respective photosensitive members 61 are transferred on the intermediate transfer belt 67 in a superimposing manner. As a result, a full-color toner image is formed on the intermediate transfer belt 67.

Further, the image forming apparatus 1 can form a monochrome image such as an image only having black color.

As described above, the toner image is (secondarily) transferred on the sheet S from the intermediate transfer belt 67 at the secondary transfer portion N. Thereafter, the sheet S is conveyed to the fixing device 45 by the pre-fixation conveying belt 44. The toner image is fixed (melted and fixed) on the sheet S with a predetermined pressurizing force by rollers opposed to each other and a belt, and heat by a heat source such as a heater in the fixing device 45.

The sheet S on which an image has been fixed is conveyed to the discharge conveying path 51 or the reverse induction path 52 via the post-fixation conveying path 59 by the discharge inner roller 46. At the branching portion of the discharge conveying path 51 and the reverse induction path 52, a switching device (not shown) that selectively switches conveying paths for the sheet S is disposed. When the sheet S is discharged from the image forming apparatus 1, the discharge conveying path 51 is selected. When the sheet S is discharged from the image forming apparatus 1 by reversing front and back sides and leading and trailing ends of the sheet S, or when an image is formed on the second surface in duplex image forming, the reverse induction path 52 is selected.

The sheet S that has been conveyed in the discharge conveying path 51 by the discharge inner roller 46 is discharged from the image forming apparatus 1 by the discharge outer roller 49. The buffer path 81 of the buffer path unit 181 of the finisher 80 is connected to the discharge conveying path 51. The sheet S that has been conveyed by the discharge outer roller 49 is sent to the post-processing unit 108 via the buffer path 81 where a post-processing is performed to the sheet S as needed. The sheet S is finally discharged to the discharge stacking portions 83a to 83d of the finisher 80.

When an image is formed on the second surface in the duplex image forming, the sheet S that has conveyed in the reverse induction path 52 is conveyed by the reverse upper roller pair 53 and the reverse lower roller pair 54 to be drawn to the switchback path 55. The leading and trailing ends of the sheet S hat has been drawn to the switchback path 55 in the conveying direction are reversed (switchback operation) by the rotation direction of the reverse lower roller pair 54 being switched to the direction opposite to that in the case where the sheet S has been drawn to the switchback path 55. Then, the sheet S is conveyed to the duplex conveying path 47 by the reverse lower roller pair 54. Thereafter, the sheet S is conveyed in the duplex conveying path 47 by the duplex rollers 48a to 48d and is sent to the conveying path 41 in synchronism with the timing of the subsequent sheet S conveyed by the sheet feeding members 35 to 38. Then, the sheet S is sent to the secondary transfer portion N via the registration roller 42. The image forming process for the backside (second surface) of the sheet S is the same as that for the front side (first surface) and the duplicate description will be omitted.

When discharging the sheet S from the image forming apparatus 1 by reversing the frontside and backside and leading and trailing ends of the sheet S in the conveying direction, the sheet S is drawn to the switchback path 55 from the reverse induction path 52 similar to the case where an image is formed on the second surface in the duplex image forming. Thereafter, the frontside and backside and the leading and trailing ends of the sheet S in the conveying direction are reversed and the sheet S goes out of the switchback path 55 by the rotation directions of the reverse upper roller pair 53 and the reverse lower roller pair 54 being switched to the direction opposite to that in the case where the sheet S is drawn to the switchback path 55. Then, the sheet S is discharged from the image forming apparatus 1 via the reverse discharge path 56 by the discharge outer roller 49, and is sent to the buffer path 81 of the finisher 80 as described above.

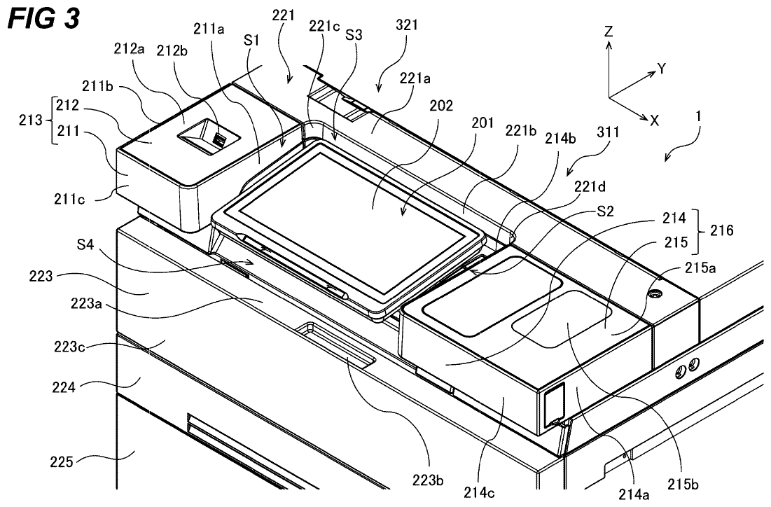

Next, the configuration characteristic to the image forming apparatus according to the present embodiment will be described by referring to FIGS. 3 to 7, 14A, and 14B. FIG. 3 is a diagram showing a perspective view of the vicinity of the operation portion 201 of the image forming apparatus 1.

The operation portion 201 has the display input portion 202 with an operation surface on which an input operation can be performed. A display portion and an input portion of the operation portion 201 uses a common touch panel system. On the display input portion 202, the information in relation to the image forming apparatus 1 is displayed. On the display input portion 202, various setting information in relation to the image forming apparatus 1 is also displayed in a predetermined area and by pressing the area, the corresponding setting is determined.

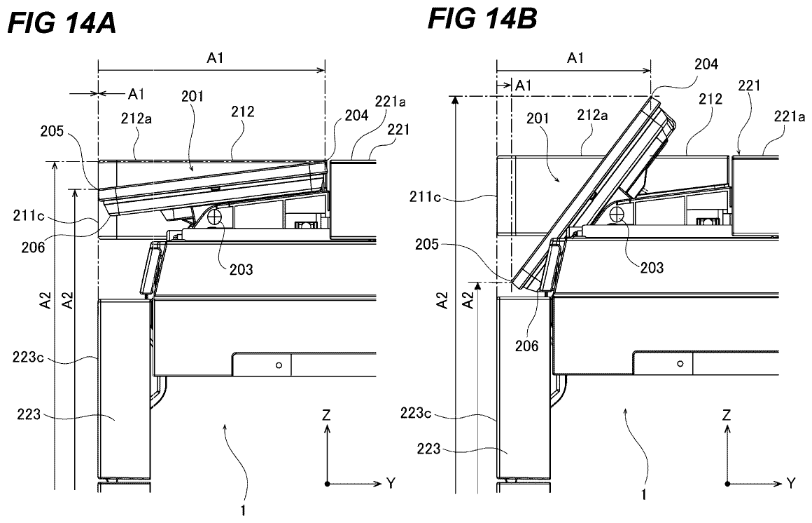

The operation portion 201 is configured to be rotatable. Next, referring to FIGS. 14A and 14B, the area in which the operation portion 201 can be operated (operational area) will be described.

For example, like Section 508 of the Rehabilitation Act in the United States, in many countries, laws and regulations related to disabilities in various countries recommend a range that users can operate comfortably or without strain based on the human scale. Human scale refers to human characteristics such as body size, muscle strength, eyesight, and field of vision.

The user's body dimensions are set to range from short: 1470 mm/Japanese/female to tall: 1880 mm/American/male, and the age range is set to 18 to 65 years old.

The operation range of the operation portion 201 is as follows: visual distance: 300 to 700 [mm], forward bending: 0 to 30 degrees, elbow flexion: 45 to 135 degrees (the state in which the arm is hanging down is considered to be 0 degrees), shoulder flexion: 0 to 90 degrees forward, reach: the range from the acromion point to the proximal interphalangeal joint of the hand so that the user can press or rotate with the fingertips, and height: the upper arm should not be raised higher than the armpit. Defined with the distance A1 from the front of the image forming apparatus 1 and the distance A2 from the bottom surface of the image forming apparatus 1, the operation range of the operation portion 201 should preferably have the distance A1: 0 to 400 [mm], and the distance A2: 900 to 1200 [mm].

As shown in FIGS. 14A and 14B, when the operation portion 201 is tilted in the range from the minimum to the maximum angle, the operation range has the distance A1: 0 to 170 mm, and the distance A2: 950 to 1100 mm, which satisfies the human scale described above. This allows for operations on a screen such as a touch panel, key operations near the screen, and detailed operations such as setting up over long periods of time.

At the left side to the operation portion 201, the front left upper box 213 constituted by the front left upper case 211 and the front left upper cover 212. The front left upper box 213 is a first outer casing member that is provided to the left side of the left end of the operation portion in the leftward and rightward directions. At the right side to the operation portion 201, the front right upper box 216 is disposed that is constituted by the front right upper case 214 and the front right upper cover 215. The front right upper box 216 is a second outer casing member that is provided to the right side of the right end of the operation portion in the leftward and rightward directions. The outer casing of the image forming apparatus 1 is partially formed by the front left upper box 213 and the front right upper box 216.

Namely, the outer casing of the image forming apparatus 1 is partially formed by the out casing of the front left upper box 213 and the out casing of the front right upper box 216.

Specifically, the outer casing of the image forming apparatus 1 is partially formed by the right side surface 211a, left side surface 211b, the front surface 211c of the front left upper case 211 of the front left upper box 213, the upper surface 212a of the front left upper cover 212, the right side surface 214a, the left side surface 214b, the front surface 214c of the front right upper case 214 of the front right upper box 216, and upper surface 215a of the front right upper cover 215.

As described above, on the front upper portion of the image forming apparatus 1, the front left upper box 213, the operation portion 201, and the front right upper box 216 are disposed from the left in this order. Further, at the rear side to the front left upper box 213, the operation portion 201, and the front right upper box 216, disposed is the main body upper front cover 221 with the width same as the distance between the left side surface 211b of the front left upper case 211 and the right side surface 214a of the front right upper case 214. Further, at the rear side to the main body upper front cover 221, the duplex automatic document feeder 312 is disposed.

The upper surface 212a of the front left upper cover 212, the upper surface 215a of the front right upper cover 215, the upper surface 221a of the main body upper front cover 221, the document base 311 of the duplex automatic document feeder 312 are on a same plane that is parallel to the installation surface of the image forming apparatus 1.

Further, under the front left upper box 213, the operation portion 201, the front right upper box 216, the front upper cover 223 is disposed. The front upper cover 223 is configured to be openable and closable in order to maintain and change the photosensitive member 61, the charging device 62, the exposure device 63 and the developing device 64 in the image forming portion 102. The upper portion of the front upper cover 223 can be opened and closed around the rotation center axis (not shown) of the X axis in the leftward and rightward directions provided in the lower portion. The outer casing of the image forming apparatus 1 is partially formed by the upper surface 223a and front surface 223c as outer casing surfaces of the front upper cover 223.

The front middle cover 224 is disposed under the front upper cover 223. Under the front middle cover 224, the front cover 225 is disposed that can be opened and closed for maintaining and changing the fixing device 45 and the intermediate transfer belt 67. On the front surface of the sheet accommodating portion 31 under the right side to the front cover 225, the right feeding cover 226 is disposed. On the front surface of the sheet accommodating portion 32 under the left side to the front cover 225, the left feeding cover 227 is disposed. On the front surface of the sheet accommodating portion 33 under the right feeding cover 226 and the left feeding cover 227, the lower feeding cover 228 is disposed.

The front surfaces of the front upper cover 223, the front middle cover 224, the front cover 225, the right feeding cover 226, the left feeding cover 227, and the lower feeding cover 228, the front surface 211c of the front left upper case 211, and the front surface 214c of the front right upper case 214 are on a same plane that is perpendicular to the installation surface of the image forming apparatus 1.

Out of the outer casing surfaces of the main body of the image forming apparatus 1, the upper surface 212a of the front left upper cover 212, the upper surface 215a of the front right upper cover 215, the upper surface 221a of the main body upper front cover 221, the upper surface 223a and the front surface 223c of the front upper cover 223 are an outer casing surfaces adjacent to the circumference of the operation portion 201. The upper surface 212a of the front left upper cover 212 is an outer casing surface adjacent to the left side of the operation portion 201. The upper surface 215a of the front right upper cover 215 is an outer casing surface adjacent to the right side of the operation portion 201. The upper surface 221a of the main body upper front cover 221 is an outer casing surface adjacent to the rear side of the operation portion 201. The upper surface 223a and the front surface 223c of the front upper cover 223 are outer casing surfaces adjacent to front lower side to the operation portion 201.

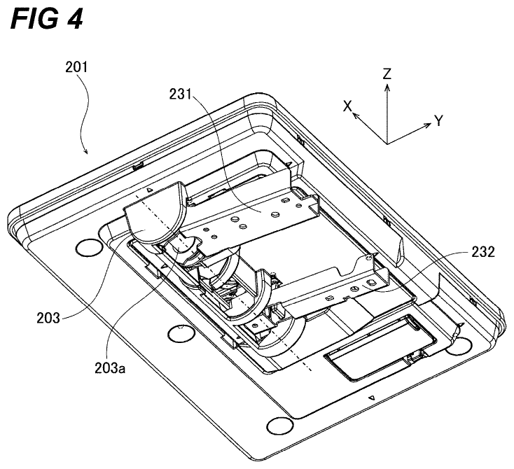

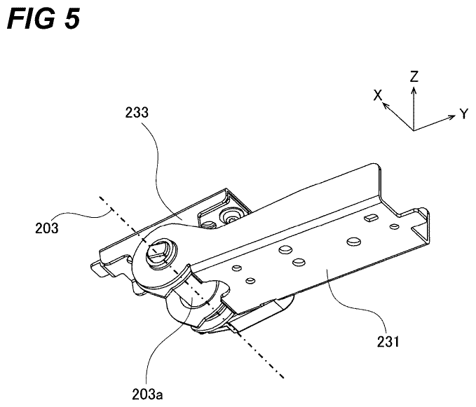

Next, the configuration of the rotation center axis of the operation portion 201 will be described referring to FIGS. 4 and 5. FIG. 4 is a diagram showing a perspective view viewed from the bottom surface of the operation portion 201. FIG. 5 is a diagram showing a detailed structure of the rotational center axis 203 of the operation portion 201.

As shown in FIG. 4, on the bottom surface of the operation portion 201, the main body right supporting plate 231 and the main body left supporting plate 232 are disposed. The main body right supporting plate 231 is for securing the operation portion 201 to the image forming apparatus 1 at the right side of the operation portion 201. The main body left supporting plate 232 is for securing the operation portion 201 to the image forming apparatus 1 at the left side of the operation portion 201. The main body right supporting plate 231 and the main body left supporting plate 232 are secured to the image forming apparatus 1.

At the right side on the bottom surface of the operation portion 201, the operation portion right securing plate 233 is secured as shown in FIG. 5. At the left side on the bottom surface of the operation portion 201, the operation portion left securing plate (not shown) is secured. As shown in FIG. 5, the operation portion right securing plate 233 is connected to the main body right supporting plate 231 via the general-purpose axial type damper hinge 203a that forms the rotation center axis 203. The operation portion left securing plate (not shown) is connected to the main body supporting plate 232 via a metal shaft (not shown) that forms the rotation center axis 203.

The axial type damper hinge 203a is used at the right side of the operation portion 201 for suppressing the impact when the operation portion 201 is rotated by a user to improve the operability of the operation portion 201 while dealing with the weight of the operation portion 201.

The axial type damper hinge 203a at the right side of the operation portion 201 controls the operational force with respect to the weight of the operation portion 201 and forms the rotation center axis 203 coaxially with the metal shaft (not shown) at the left side of the operation portion 201.

The operation portion 201 can be rotated around the rotation center axis 203 such that the display input portion 202 serving as an operation surface on which an input operation can be performed can take an inclined posture.

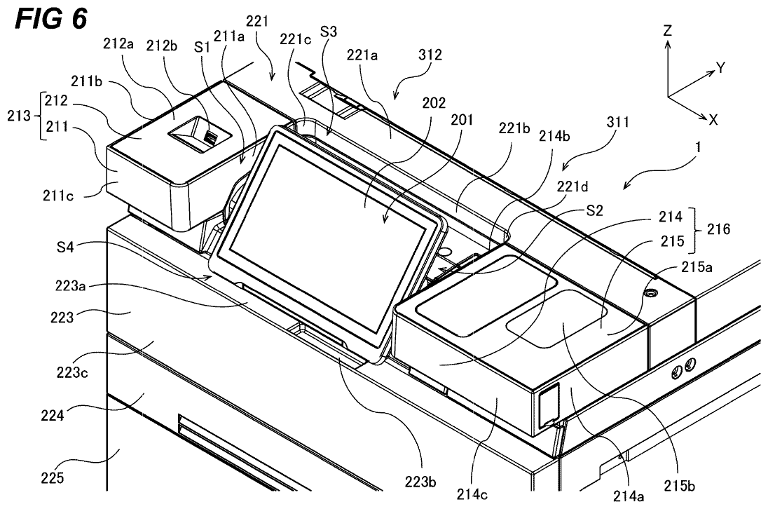

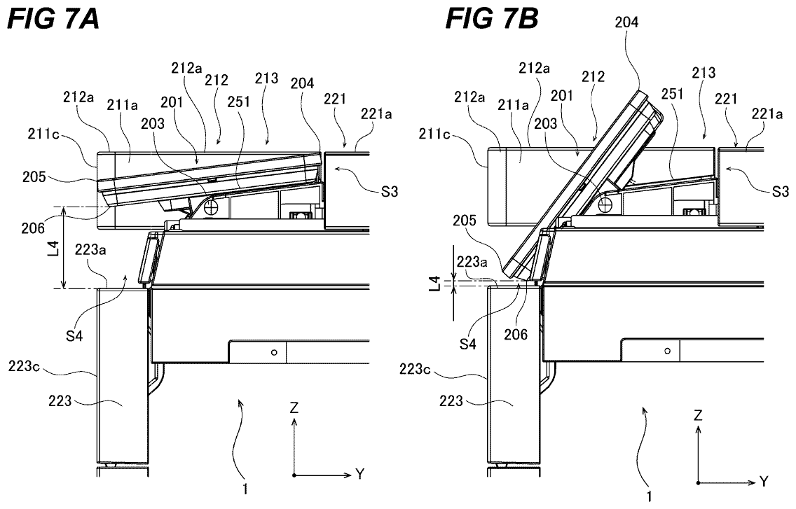

Next, the rotation of the operation portion 201 will be described with reference to FIGS. 3, 6, 7A and 7B. FIG. 3 is a diagram showing a perspective view of the vicinity of the operation portion 201 rotated with a minimum inclined angle of the operation portion 201 (first posture). FIG. 6 is a diagram showing a perspective view of the vicinity of the operation portion 201 rotated with a maximum inclined angle of the operation portion 201 (second posture). FIGS. 7A and 7B are explanatory diagrams showing a rotation operation of the operation portion 201 viewed from right side surface. FIG. 7A shows the state where the operation portion 201 has the minimum inclined angle (first posture) and FIG. 7B shows the state where the operation portion 201 has the maximum inclined angle (second posture).

In the present embodiment, the operation portion 201 is configured to be rotatable around the rotation center axis 203 between the first posture (FIG. 3) in which the display input portion 202 is inclined with respect to the horizontal surface perpendicular to the vertical direction and the second posture (FIG. 6) in which the display input portion 202 is more inclined than the first posture. As shown in FIGS. 7A and 7B, viewed along the leftward and rightward directions, the front left upper box 213 and the rotation center axis 203 overlap with each other. Similarly, viewed along the leftward and rightward directions, the front right upper box 216 and the rotation center axis 203 overlap with each other. Further, viewed from the direction perpendicular to the surface of the display input portion 202, the rotation center axis 203 and the display input portion 202 overlap with each other.

As shown in FIG. 7A, the operation portion 201 is rotated around the rotation center axis 203 in the clockwise direction so that the operation portion 201 is in the state where the display input portion 202 is inclined such that the display input portion 202 has the least angle (minimum angle) with respect to the installation surface (horizontal surface) of the image forming apparatus. In this state, the rotation of the operation portion 201 in the clockwise direction is restricted by a rotation restricting portion (not shown) and the operation portion 201 is maintained in the first posture (position) shown in FIGS. 3 and 7A. The posture of the operation portion 201 shown in FIGS. 3 and 7A is the first posture. The first posture of the operation portion 201 is not a horizontal posture where the frontmost portion 205 of the operation portion 201 in the forward and backward directions is in the same position of the rearmost portion 204, but an inclined posture where the frontmost portion 205 of the operation portion 201 in the forward and backward directions is in the position lower than that of the rearmost portion 204.

When the operation portion 201 takes the first posture shown in FIGS. 3 and 7A, the rearmost portion 204 of the operation portion 201 as being an uppermost portion does not protrude outwardly (upwardly) from the upper surface 212a of the front left upper cover 212, the upper surface 215a of the front right upper cover 215, the upper surface 221a of the main body upper front cover 221, and the document base 311 of the duplex automatic feeder 312, which are on almost the same plane. Namely, when the operation portion 201 takes the first posture, the rotation of the operation portion 201 is restricted by a rotation restricting portion (not shown) such that the rearmost portion 204 of the operation portion 201, which is the uppermost portion takes the position that is equal in height to or lower than those of the upper surfaces 212a, 215a and 221a, which are outer casing surfaces adjacent to the circumference of the operation portion.

After a user places a document on the document base 311 of the duplex automatic document feeder 312 for reading the document, the document might be removed by moving the read document to the front side. In the configuration in which the operation portion 201 is disposed at the front side to the document base 311, a document might be in contact with the rearmost portion 204 so that the user's operation of removing the document might be hindered depending on the relationship between the height of the document base 311 and the height of the rearmost portion 204 in the vertical directions. With the configuration of the present embodiment, in which the rearmost portion 204 is disposed in a position lower than the outer casing surfaces adjacent to the circumference of the operation portion, the risk that the user's operation of removing a document from the document base 311 is hindered can be reduced.

Further, when the operation portion 201 takes the first posture shown in FIGS. 3 and 7A, the frontmost portion 205 of the operation portion 201 does not protrude outwardly (forwardly) from the front surface 211c of the front left upper case 211, the front surface 214c of the front right upper case 214, the front surface 223c of the front upper cover 223, which are on almost the same plane. Namely, when the operation portion 201 takes the first posture, the rotation of the operation portion 201 is restricted by a rotation restricting portion (not shown) such that the frontmost portion 205 of the operation portion 201 takes the position equal to or more rear in the forward and backward directions than those of the front surfaces 211c, 214c and 223c, which are outer casing surfaces adjacent to the circumference of the display input portion 202 as an operation surface.

As described above, the first posture of the operation portion 201 is a posture in which any portion of the operation portion 201 does not protrude outwardly from the upper surfaces 212a, 215a and 221a, the front surfaces 211c,214c and 223c, which are the outer casing surfaces adjacent to the circumference of the operation portion 201. Specifically, the first posture of the operation portion 201 is a posture in which the operation portion 201 does not protrude outwardly from the upper surfaces 212a, 215a and 221a, which are the outer casing surfaces adjacent to the circumference of the operation portion 201 in the vertical directions. Further, the first posture of the operation portion 201 is a posture in which the operation portion 201 does not protrude outwardly from the front surfaces 211c, 214c and 223c, which are the outer casing surfaces adjacent to the circumference of the operation portion 201 in the forward and backward directions.

With this configuration, visibility and operability of the operation portion 201 can be improved as compared with the case where the operation portion in the posture in which the operation surface is horizontal is operated.

On the other hand, as shown in FIG. 7B, the operation portion 201 in the state where the operation portion 201 is rotated around the rotation center axis 203 in the counterclockwise direction and and the display input portion 202 is inclined with the greatest angle (maximum inclined angle) with respect to the installation surface of the image forming apparatus (horizontal surface). In this case, the rotation of the operation portion 201 in the counterclockwise direction is restricted by a rotation restricting portion (not shown) so that the operation portion 201 is maintained in the second posture (position) shown in FIGS. 6 and 7B. The posture of the operation portion 201 shown in FIGS. 6 and 7B is the second posture. The display input portion 202 of the operation portion 201 in the second posture is more inclined with respect to the installation surface of the image forming apparatus (horizontal surface) than that in the first posture.

When the image forming apparatus is being transported or after the image forming apparatus has been installed, if the frontmost portion 205 protrudes forwardly from the front surfaces 211c and 214c, there is a risk that the the operation portion 201 is broken by an impact in a case where a surrounding object comes in contact with the frontmost portion 205. On the other hand, in the present embodiment, the frontmost portion 205 does not protrude from the front surfaces 211c and 214c in any of the cases where the operation portion 201 takes the first posture and the second posture. As a result, a surrounding object comes in contact with the front surface 211c or the front surface 214c before the frontmost portion 205, enabling to reduce the risk that the operation portion 201 is broken by the impact of the contact.

Further, when the operation portion 201 takes the second posture shown in FIGS. 6 and 7B, the frontmost portion 205 of the operation portion 201 does not protrude outwardly (forwardly) from the front surface 211c of the front left upper case 211, the front surface 214c of the front right upper case 214, the front surface 223c of the front upper cover 223, which are on almost the same plane. Namely, when the operation portion 201 takes the second posture, the rotation of the operation portion 201 is restricted by a rotation restricting portion (not shown) such that the frontmost portion 205 of the operation portion 201 takes the position equal to or more rear in the forward and backward directions than those of the front surfaces 211c, 214c and 223c, which are outer casing surfaces adjacent to the circumference of the display input portion 202 as an operation surface.

Next, the working space for the rotation operation of the operation portion 201 will be described with reference to FIGS. 3, 8 to 10.

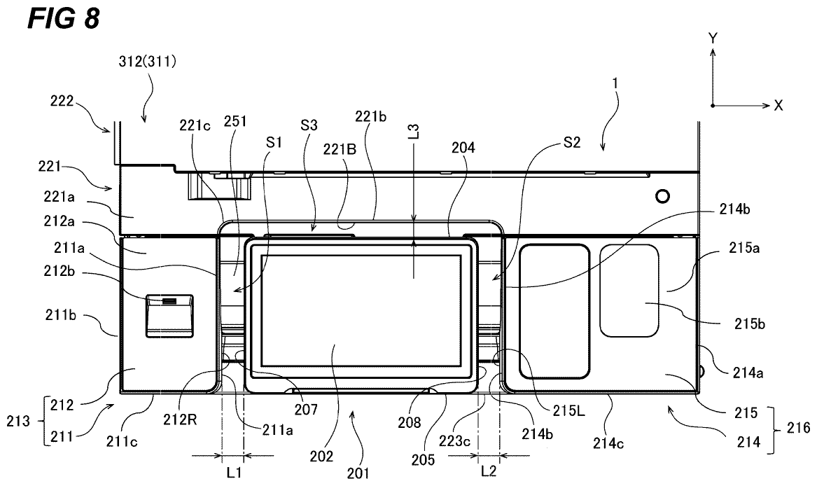

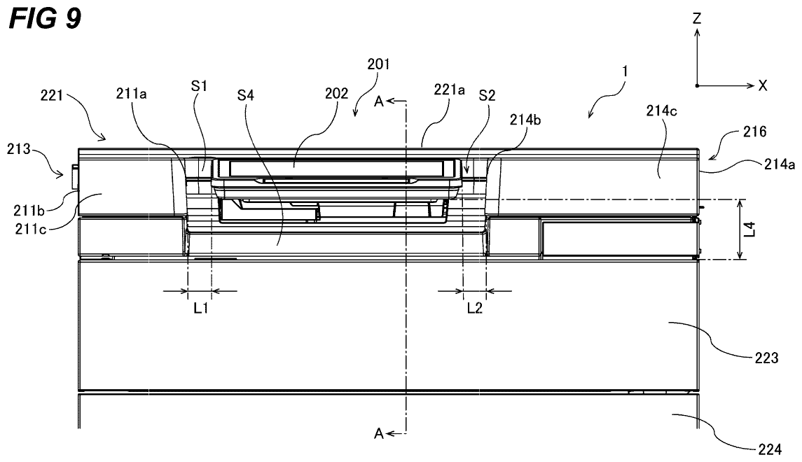

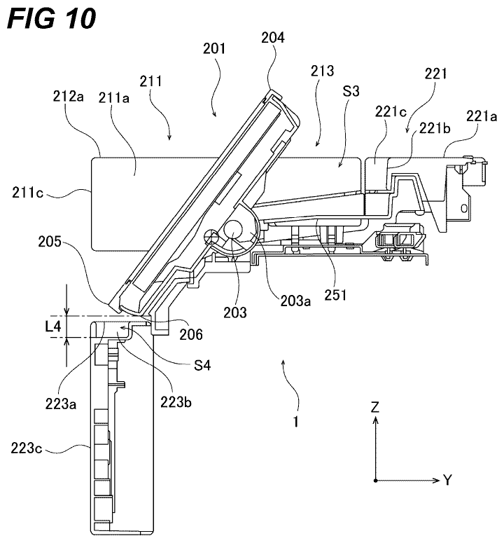

FIG. 8 is a diagram showing a top view of the operation portion 201 in the first posture viewed from the above in the vertical directions. FIG. 9 is a diagram showing a front view of the operation portion 201 in the first posture viewed from the front side in the forward and backward directions. FIG. 10 is a diagram showing a cross-sectional view of about the center portion (A-A cross section shown in FIG. 9) of the operation portion 201 in the second posture.

As shown in FIGS. 3 and 8, when the display input portion 202 of the operation portion 201 is viewed from the above in the vertical directions, the working spaces S1, S2, S3 and S4 are respectively provided for placing a finger on the operation portion 201 between the operation portion 201 and the upper surfaces 212a, 215a and 221a and the front surface 223c, which are outer casing surfaces adjacent to the circumference of the operation portion 201. A user can perform an operation of rotating the operation portion 201 around the rotation center axis by placing a finger on the operation portion 201. Therefor, the working spaces S1, S2, S3 and S4 are provided as gaps into which a user can insert a finger to perform the operation of rotation.

The working spaces S1, S2, S3 and S4 for placing a finger on the operation portion 201 are respectively provided between the operation portion 201 and the upper surfaces 212a, 215a and 221a that are outer casing surfaces adjacent to the rear side in the forward and backward directions, the left side and right side in leftward and rightward directions to the operation portion 201.

The operation portion 201 is of a substantially a rectangular shape so that the edges in the rightward and leftward directions are longer than the those in the forward and backward directions. The spaces for placing a finger on the operation portion 201 are provided between at least one edge of the operation portion 201 and one edge of the outer casing surface adjacent to the at least one edge of the operation portion 201.

Specifically, the working space S1 for placing a finger on the operation portion 201 is provided between the left end portion 207 that is a left end edge of the operation portion 201 in the first posture and the right end portion 212R that is an edge of the upper surface 212a adjacent to the left end portion 207 of the operation portion 201. The right end portion 212R that is an edge of the upper surface 212a is a ridgeline formed by the upper surface 212a of the front left upper cover 212 and the right side surface 211a of the front left upper case 211 being crossed.

In the present embodiment, as shown in FIGS. 8 and 9, the width L1 in the leftward and rightward directions of the working space S1 between the left end portion 207 of the operation portion 201 and the right end portion 212R of the front left upper case 211 in the first posture of the operation portion 201 is set to about 20 to 30 [mm].

The working space S2 for placing a finger on the operation portion 201 is provided between the right end portion 208 that is a right end edge of the operation portion 201 in the first posture and the left end portion 215L that is an edge of the upper surface 215a adjacent to right end portion 208 of the operation portion 201. The left end portion 215L that is an edge of the upper surface 215a is a ridgeline formed by the upper surface 215a of the front right upper cover 215 and the left side surface 214b of the front right upper case 214 being crossed.

In the present embodiment, as shown in FIGS. 8 and 9, the width L2 in the leftward and rightward directions of the working space S2 between the right end portion 208 of the operation portion 201 and the left end portion 215L of the front right upper case 214 in the first posture of the operation portion 201 is set to about 20 to 30 [mm].

The working space S3 for placing a finger on the operation portion 201 is provided between the rearmost portion 204 that is a rear end edge of the operation portion 201 in the first posture and the front end portion 221B that is an edge of the upper surface 221a adjacent to the rearmost portion 204 of the operation portion 201. The front end portion 221B that is an edge of the upper surface 221a is a ridgeline formed by the upper surface 221a and the front surface 221b of the main body upper front cover 221 being crossed.

In the present embodiment, as shown in FIGS. 8 and 9, the width L3 in the leftward and rightward directions of the working space S3 between the rearmost portion 204 of the operation portion 201 in the first posture and the front end portion 221B of the main body upper front cover 221 is set to about 20 [mm].

Additionally, the working space S4 for placing a finger on the operation portion 201 is provided between the front end lowermost portion 206 of the operation portion 201 in the first posture and the upper surface 223a adjacent to the front end lowermost portion 206 of the operation portion 201.

In front of the frontmost portion 205 of the operation portion 201 in the first posture, there is no outer casing surfaces adjacent to the front side in the forward and backward directions of the operation portion 201. Therefore, the working space S4 is located in front of the frontmost portion 205 of the operation portion 201 and under the frontmost portion 205.

Further, the frontmost portion 205 of the operation portion 201 in the first posture does not protrude forwardly in the forward and backward directions from the front surface 223c of the front upper cover 223 as an outer casing surface. Furthermore, the frontmost portion 205 of the operation portion 201 in the second posture does not protrude forwardly in the forward and backward directions from the front surface 223c of the front upper cover 223 as an outer casing surface. Namly, when the operation portion 201 is in the first posture or in the second posture, the frontmost portion 205 of the operation portion 201 in the forward and backward directions does not protrude forwardly in the forward and backward directions from the front surface 223c of the front upper cover 223 as an outer casing surface.

In the present embodiment, as shown in FIGS. 8 and 9, the height L4 in the upward and downward directions of the working space S4 between the front end lowermost portion 206 of the operation portion 201 in the first posture and the upper surface 223a of the front upper cover 223 is set to about 70 [mm].

In the present configuration, when changing the angle of the operation portion 201 in the state of the minimum inclined angle, the angle of the operation portion 201 can be changed by gripping at least one of the left end, the right end, the rear end and the front end of the operation portion 201 after accessing them through the working spaces S1, S2 at the left side and the right side to the operation portion 201, the working space S3 at the rear side to the operation portion 201, or the working space S4 at the front side of and under the operation portion 201, which are enough wording spaces. Therefore, the operability of the operation portion 201 can be improved.

When the operation portion 201 is in the state where the operation portion 201 is inclined with maximum inclined angle as shown in FIGS. 6 and 7B, the rear end portion of the operation portion 201 in the position higher than the the upper surface 221a of the main body upper front cover 221 in the working space S3. Therefore, the working space S3 provides an enough space for operating the operation portion 201. Namely, as compared with the state where the operation portion 201 is inclined with the minimum inclined angle, it is easier to grip the end portion of the operation portion 201 and to change the angle of the operation portion 201.

On the other hand, when the operation portion 201 is in the state where the operation portion 201 is inclined with maximum inclined angle, the height L4 of the working space S4 between the front end lowermost portion 206 of the operation portion 201 and the upper surface 223a of the front upper cover 223 is less than 10 [mm]. Therefore, the working space S4 does not provide an enough space for operating the operation portion 201. Therefore, as shown in FIG. 10, the recessed portion 223b that is a downwardly recessed portion of the upper surface 223a of the front upper cover 223 is provided in order to change the angle of the operation portion 201 with the tip of the operation portion 201 being gripped. With this configuration, the height L4 of the working space S4 between the front end lowermost portion 206 of the operation portion 201 and the upper surface 223a of the front upper cover 223 becomes greater than 10 [mm], which provides an enough working space so that the operability of the operation portion 201 can be improved.

The settings of the widths L1 to L3 and the height L4 are preferably performed based on the above described human scale. In the present embodiment, the widths L1 to L3 and the height L4 are determined with which an average American male can perform an operation based on the average size of American males, which is relatively big in the corporal sizes of users. The above-described values of the widths L1 to L3 and the height L4 are just examples and they may have different values. Namely, the above values can be appropriately changed in accordance with the corporal size of a user who is assumed to use the products.

The recessed portion 223b of the front upper cover 223 has also the function of a handle in opening the front upper cover 223 for the maintenance and the exchange of the photosensitive member 61 of the image forming portion 102, the charging device 62, the exposure device 63, the developing device 64.

As shown in FIGS. 3, 6 and 8, the right side surface 211a of the front left upper case 211, the left side surface 214b of the front right upper case 214, the front surface 221b of the main body upper front cover 221, the left corner wall surface 221c of the main body upper front cover 221, and the right corner wall surface 221d of the main body upper front cover 221 are disposed inside the operation portion lower cover 251 indicated in the top view of the operation portion 201 shown in FIG. 8. With this configuration, the beauty of the circumference of the operation portion is ensured so that it excels in the design's perspective.

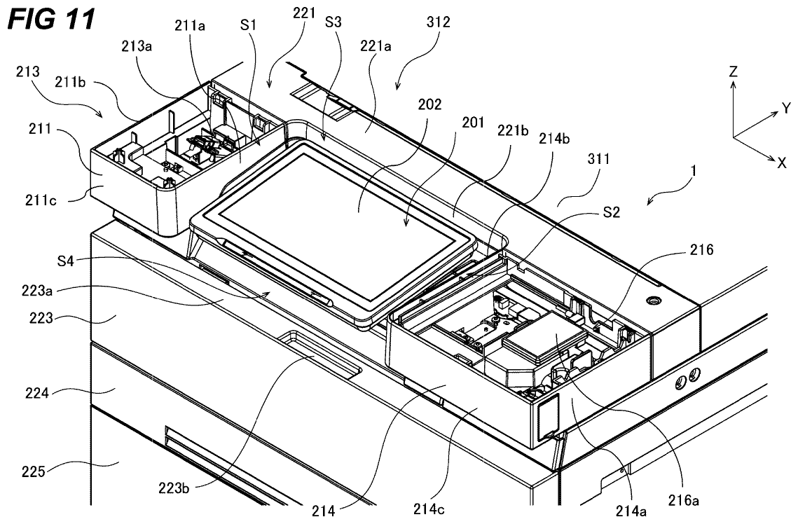

Next, the inside configurations of the front left upper box 213 located in the left side to the operation portion 201 and the front right upper box 216 located in the right side to the operation portion 201 will be described referring to FIGS. 11 to 13.

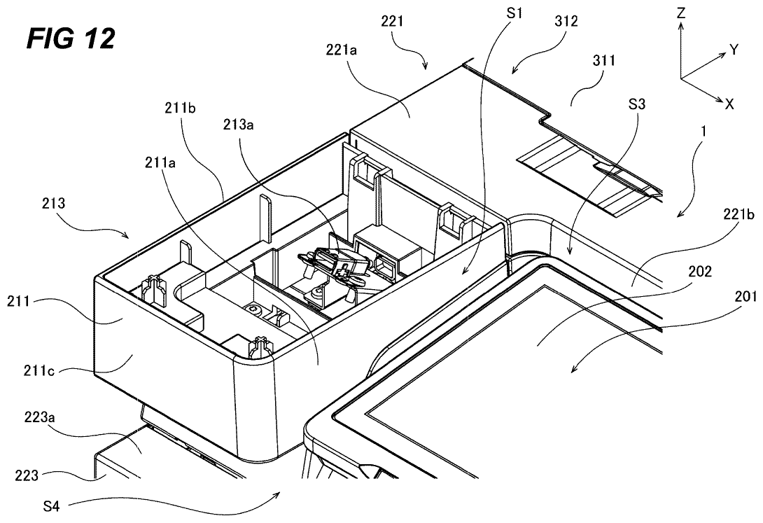

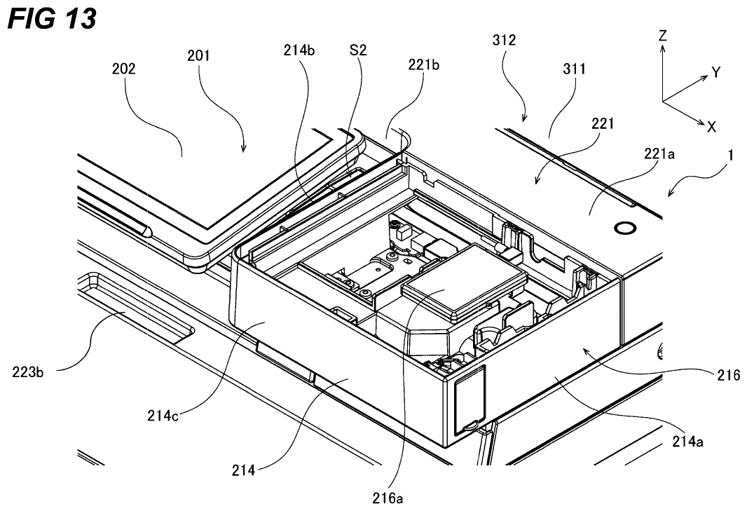

FIG. 11 is a diagram showing a perspective view of the inner structures of the front left upper box 213 and the front right upper box 216 which are outer casings placed at the left side and the right side to the operation portion. FIG. 12 is a diagram showing a partially enlarged perspective view of the inner structure of the front left upper box 213 as an outer casing placed at the left side to the operation portion. FIG. 13 is a diagram showing a partially enlarged perspective view of the inner structure of the front right upper box 216 as an outer casing placed at the right side to the operation portion. FIGS. 11 to 13 show the state where the engagement of the front left upper cover 212 engaged at the front left upper case 211 and the front right upper cover 215 engaged at the front right upper case 214 by an engagement claw (not shown) is released, and the front left upper cover 212 and the front right upper cover 215 are removed.

In at least one of the front left upper box 213 and the front right upper cover 215 that are respectively provided at the left side or the right side in the rightward and leftward directions to the operation portion 201, a user access portion is provided for a user to get access thereto.

In FIGS. 11 and 12, the USB connector 213a as a user access portion can be placed on the front left upper case 211 in the front left upper box 213. The USB connector 213a is connected to a control portion (not shown) of the image forming apparatus 1 via a cable (not shown). Then, the front left upper cover 212 is engaged to the front left upper case 211. As shown in FIG. 3, the opening 212b opposed to the connector port of the USB connector 213a is provided on the front left upper cover 212. The storage medium (for example, USB memory) corresponding to the specifications of the USB connector 213a and storing various data (not shown) is set to the USB connector 213a. Then, the image forming apparatus 1 reads the data in the storage medium and the data can be printed out by the image forming apparatus.

In FIGS. 11 and 13, the IC card reader 216a as a user access portion can be placed on the front right upper case 214 in the front right upper box 216. The IC card reader 216a is an example of an authentication apparatus. The IC card reader 216a is connected to a control portion (not shown) of the image forming apparatus 1 via a cable (not shown). Then, the front right upper cover 215 is engaged to the front right upper case 214. When an IC card (not shown) is put near or brought in contact with the IC card recognition area 215b (see FIG. 3) of the front right upper cover 215 that is placed immediately above the IC card reader 216a, the authentication of the IC card can be performed.

In view point of improving the operability for a user, it is desirable that a user access portion is provided in the vicinity of the operation portion 201. However, when a user access portion is provided at an outer casing surface adjacent to the operation portion that can be rotated, the user access portion provided in the vicinity could hinder the operation of rotating the operation portion by a user, which might lower the operability. By forming the working spaces S1 to S4 for rotating the operation portion 201 as described in the present embodiment, the lowering of the operability of a user can be suppressed even when a user access portion is provided in the vicinity of the operation portion 201.

The USB connector 213a and the IC card reader 216a are taken up as examples of devices to which a user gets access (user access portions). However, the user access portions are not limited to these elements. As a user access portion, an NFC (Near Field Communication) board or a BLE (Bluetooth Low Energy) board can be used.

In the present embodiment, the USB connector 213a as a user access portion is disposed on the the front left upper box 213 located at the left side to the operation portion and the IC card reader 216a as a user access portion is disposed on the front right upper cover 215 located at the right side to the operation portion. However, the present disclosure is not limited to this configuration. A user access portion can be provided on either one of the outer casing surfaces provided at the left side or the right side to the operation portion 201 in the leftward and rightward directions. Further, a plurality of access portions can be provided on either one of the outer casing surfaces.

According to the present embodiment, the working spaces S1 to S4 are respectively provided between the operation portion 201 and the outer casing surfaces adjacent to the circumference of the operation portion 201. With this configuration, the working spaces S1 to S4 for rotating the operation portion 201 are formed. As a result, the accessibility of the operation portion 201 is improved. Further, the visibility and the operability can be improved by rotating the operation portion to an angle appropriate to a user.

Further, the configuration in which the working spaces S1 to S4 are provided for all the (four) edges of the operation portion 201 that is substantially of a rectangular shape is exemplified. However, the configuration is not limited to this one. It is sufficient that the working spaces S1 to S4 is provided for at least one edge of the operation portion 201 that is of about a rectangular shape on a plane. Furthermore, a working space is can be provided for a part of any edge of the operation portion 201. With this configuration, the operation portion 201 can be accessed from at least one edge of the operation portion 201 and the angle of the operation portion 201 is adjustable to a suitable angle for a user.

The working spaces S1 to S4 are respectively provided between the operation portion 201 and the upper surfaces 212a, 215a and 221a in the posture in which the operation portion 201 does not upwardly protrude in the vertical directions from the upper surfaces 212a, 215a and 2212a that are outer casing surfaces adjacent to the circumference of the operation portion 201. With this configuration, accessibility to the operation portion 201 is improved and the angle of the operation portion 201 is adjustable to an appropriate angle for a user.

In front of and under the front end of the operation portion 201, the opened working space S4 is provided. With this configuration, the front end portion of the operation portion 201 can be gripped and the angle of the operation portion 201 is adjustable to an appropriate angle for a user.

As one of the spaces in the circumference of the operation portion 201, the recessed portion 223b is provided on the front upper cover 223 that is an outer casing under the operation portion 201. With this configuration, the recessed portion 223b can be used as the working space S4 in order to ensure a working space, so that the angle of the operation portion 201 is adjustable.

In at least one of the front left upper box 213 and the front right upper box 216 that are respectively provided at the left side and the right side to the operation portion 201, a user device to which a user gets access is disposed. With this configuration, the spaces in the front left upper box 213 and the front right upper box 216 disposed at the left side and the right side to the operation portion 201 can be effectively utilized, enabling a user to get access to the user device from the front side to the image forming apparatus 1.

The USB connector 213a, the IC card reader 216a are mounted as user access portions. With this configuration, an access to the user access portion that has high versatility can be made easy.

In the above embodiment, the image forming portion has four image forming modules. However, the number of image forming modules is not limited to four and an appropriate number can be selected as required.

In the above embodiment, a copying machine is exemplified as an image forming apparatus. However, the present disclosure is not limited to this configuration. The present disclosure can be applied to another image forming apparatus such as a printer, a facsimile apparatus, and a multi-functional machine with these functions combined. Further, the present disclosure can be applied to an image forming apparatus in which a recording material bearing member is used, and toner images of respective colors are transferred in a sequentially superimposed manner on a recording material borne on the recording material bearing member. By applying the present disclosure to these image forming apparatus, the same effect can be obtained.

In the above-described embodiment, the electrophotographic system is exemplified as a recording system. However, the recording system is not limited to this and another recording system such as the inkjet system can be used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-207025, filed Nov. 28, 2024, which is hereby incorporated by reference herein in its entirety.

What is claimed is:

1. An image forming apparatus comprising:
an apparatus main body having outer casing surfaces; and
an operation portion having an operation surface on which an input operation can be performed, the operation portion being configured to be rotatable around a rotation center axis such that the operation surface can take an inclined posture,
wherein a user places a finger on the operation portion to perform a rotating operation of the operation portion around the rotation center axis, and
wherein when viewing the operation surface of the operation portion from the above in the vertical directions, a gap is provided into which a user can insert a finger for performing the rotating operation between the operation portion and an outer casing surface adjacent to a circumference of the operation portion out of the outer casing surfaces.

2. The image forming apparatus according to claim 1,
wherein a gap is provided into which a user can insert a finger for performing the rotating operation between the operation portion and the outer casing surface adjacent to at least one of a rear side of the operation portion in forward and backward directions, a left side of the operation portion in leftward and rightward directions, and a right side of the operation portion in leftward and rightward directions.

3. The image forming apparatus according to claim 1,
wherein the operation portion is substantially of a rectangular shape, and
wherein a gap is provided into which a user can insert a finger for performing the rotating operation between at least one edge of the operation portion and one edge of the outer casing surface adjacent to the at least one edge of the operation portion.

4. The image forming apparatus according to claim 3,
wherein a space located in front of and under a frontmost portion of the operation portion belongs to the gap.

5. The image forming apparatus according to claim 1,
wherein a frontmost portion of the operation portion in forward and backward directions does not protrude forwardly in the forward and backward directions from the outer casing surface adjacent to the circumference of the operation portion.

6. The image forming apparatus according to claim 1,
wherein in at least one of the outer casing surfaces provided at a left side and a right side to the operation portion in leftward and rightward directions, a user access portion to which a user gets access is disposed.

7. The image forming apparatus according to claim 6,
wherein the user access portion has at least one of a USB connector or an IC card.

8. The image forming apparatus according to claim 1,
wherein in a posture in which the operation portion does not protrude upwardly in upward and downward directions from an outer casing surface adjacent to the circumference of the operation portion out of the outer casing surfaces, a space for placing a finger on the operation portion between the operation portion and the outer casing surface adjacent to the circumference of the operation portion out of the outer casing surfaces.

9. The image forming apparatus according to claim 1,
wherein a transfer portion configured to transfer an image onto a sheet and a fixing portion configured to fix an image on a sheet are disposed on a sheet conveying path in leftward and rightward directions.
